(19) United States
(12) Patent Application Publication
(10) Pub. No.: US 2015/0169880 A1
(43) Pub. Date: Jun. 18, 2015

(54) FILE PROCESSING METHOD AND ELECTRONIC DEVICE SUPPORTING THE SAME

(71) Applicant: Samsung Electronics Co., Ltd., Gyeonggi-do (KR)

(72) Inventor: Sang Hyun Kim, Busan (KR)

(21) Appl. No.: 14/574,225

(22) Filed: Dec. 17, 2014

(30) Foreign Application Priority Data
Dec. 17, 2013 (KR) 10-2013-0157610

(51) Int. Cl. G06F 21/60

(52) U.S. Cl. CPC G06F 21/60

(57) ABSTRACT

A file processing method is provided. The method includes providing a non-security environment or security environment. The method also includes storing a file including reading a normal file from a normal region in a storage unit related to the non-security environment during execution of the non-security environment to write a read file to a secure region of the storage unit operating in the security environment, reading a secure file from the secure region in the security environment to write a read file to the normal region, or reading the normal file from the normal region in the security environment to write a read file to the secure region.

### CROSS-REFERENCE TO RELATED APPLICATION(S) AND CLAIM OF PRIORITY

The present application is related to and claims priority to Korean Application Serial No. 10-2013-0157610, which was filed in the Korean Intellectual Property Office on Dec. 17, 2013, the entire content of which is hereby incorporated by reference.

### TECHNICAL FIELD

The present invention relates to file processing by an electronic device.

### BACKGROUND

Portable electronic devices have been distributed, so many people are using the electronic devices. These electronic devices are supporting a function of storing and playing various files.

Typical electronic devices are vulnerable to illegal usage such as hacking or phishing or leakage of information not intended by a user. In order to complement such weakness, various security systems are being developed. For example, typical electronic devices are supporting a security environment in which a password security function has been added for complementing the weakness. In this case, since a non-security environment not supporting the password security function and the security environment operate independently, file sharing therebetween may not be supported.

A file non-sharing state as described above is needed for supporting a security function but a file operating in a non-security environment may be needed to operate in a security environment depending on the situation. Also, a file operating in the security environment may be needed to operate in the non-security environment depending on the situation.

### SUMMARY

To address the above-discussed deficiencies, it is a primary object to provide a file processing device that maintain security and also support an appropriate file sharing function, and an electronic device supporting the same.

In a first embodiment, an electronic device supporting file processing is provided. The electronic device includes a storage unit configured to include a normal region storing a normal file related to a function operating in a non-security environment and a secure region storing a secure file related to a function operating in a security environment. The electronic device also includes a control unit configured to read the normal file stored in the normal region in response to a file transfer request in the non-security environment to write a read file to the secure region, or read the secure file stored in the secure region in the security environment in response to a file transfer request in the security environment to write a read file to the normal region.

In a second embodiment, a file processing method is provided. The method includes providing a non-security environment or security environment; and storing a file including reading a normal file from a normal region in a storage unit related to the non-security environment during execution of the non-security environment to write a read file to a secure region of the storage unit operating in the security environment. The method also includes reading a secure file from the secure region in the security environment to write a read file to the normal region, or reading the normal file from the normal region in the security environment to write a read file to the secure region.

Before undertaking the DETAILED DESCRIPTION below, it be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device be implemented in hardware, firmware or software, or some combination of at least two of the same. It should be noted that the functionality associated with any particular controller be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram of an example electronic device supporting a file processing function according to this disclosure.

FIG. 2 is a diagram of example configurations of a storage unit and a control unit of file processing function related configurations according to this disclosure.

FIG. 3 is a diagram illustrating an example transmission and reception of a file processing function related signal according to this disclosure.

FIG. 4 is a diagram illustrating an example file processing method in a non-security environment according to this disclosure.

FIG. 5 is a diagram illustrating an example file processing method in a security environment according to this disclosure.

FIGS. 6A, 6B, 6C, and 6D are diagrams illustrating example file processing related screen interfaces in a non-security environment according to this disclosure.

FIGS. 7A, 7B, 7C, and 7D are diagrams illustrating example file processing related screen interfaces in a security environment according to this disclosure.

### DETAILED DESCRIPTION

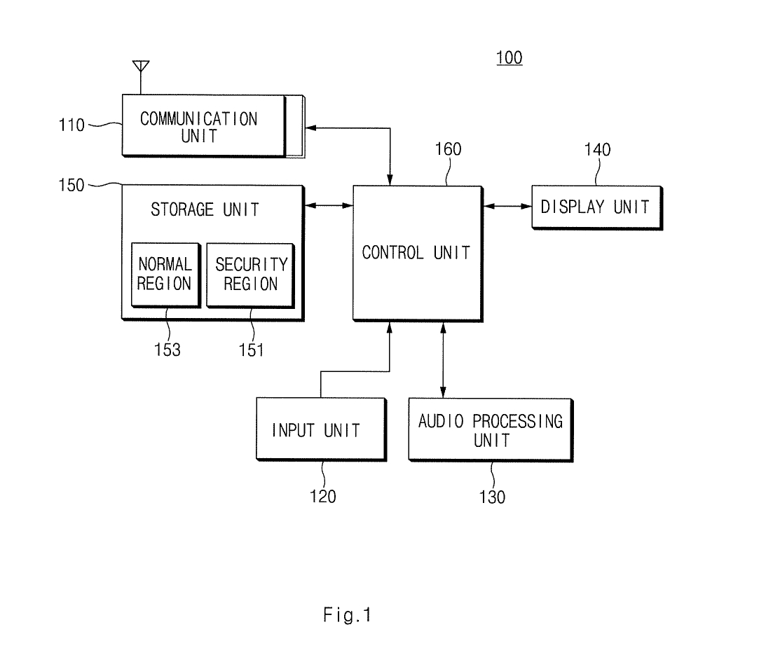

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure be implemented in any suitably arranged electronic device. The present disclosure is described below with reference to the accompanying drawings. Since the present disclosure may implement various modifications and have many embodiments, particular embodiments are illustrated in the drawings and described in the detailed description. However, it is not intended to limit the present disclosure to particular embodiments, and it should be understood that the present disclosure covers all modifications, equivalents, and/or replacements that fall within the spirit and technical scope of the present disclosure. In describing the drawings, similar components are denoted through the use of similar reference numerals.

The expression “include” or “may include” that may be used in the present disclosure indicates the presence of a disclosed corresponding function, operation or component but does not exclude one or more functions, operations or components in addition. Also, in the present disclosure, it should be understood that the term “includes” or “has” indicates the presence of characteristics, numbers, steps, operations, components, parts or combinations thereof represented in the present disclosure but does not exclude the presence or addition of one or more other characteristics, numbers, steps, operations, components, parts or combinations thereof.

The expression “or” in the present disclosure includes any and all combinations of enumerated words. For example, the expression “A or B” may include A, B, or both A and B.

The expression “a first”, “a second”, “firstly”, or “secondly” in the present disclosure may modify various components of the present invention but does not limit corresponding components. For example, the expressions above do not limit the order and/or importance of corresponding components. The expressions above may be used to distinguish one component from another. For example, both a first user device and a second user device are user devices that are mutually different user devices. For example, without departing from the scope of rights of the present invention, a first component may be called a second component and similarly, the second component may also be called the first component.

When it is mentioned that any component is “connected” or “accessed” to another component, it should be understood that the former may be directly connected to the latter, or there may be another component in between. On the contrary, when it is mentioned that any component is “directly connected” or “directly accessed” to another component, it should be understood that there may be no other component in between.

The terms used in the present disclosure are used only to describe specific embodiments and are not intended to limit the present disclosure. The terms in singular form include the plural form unless otherwise specified.

Unless otherwise defined herein, all terms used herein including technical or scientific terms have the same meanings as those generally understood by a person skilled in the art. Terms defined in generally used dictionaries should be construed to have meanings matching contextual meanings in the conventional art and should not be construed as having an ideal or excessively formal meaning unless otherwise defined herein.

For example, an electronic device according to the present disclosure may include at least one selected from the group consisting of a smart phone, a tablet personal computer (PC), a mobile phone, a video phone, an e-book reader, a desktop PC, a laptop PC, a net book computer, a personal digital assistant (PDA), a portable multimedia player (PMP), an MP3 player, a mobile medical device, a camera, and a wearable device (such as, a head-mounted-device (HMD) such as electronic glasses, electronic clothing, an electronic bracelet, an electronic necklace, an electronic appcessory, an electronic tattoo, or a smart watch).

According to some embodiments, the electronic device may be a smart home appliance. The smart home appliance may include, for example, at least one of the group consisting of a TV, a digital video disk (DVD) player, an audio set, a refrigerator, an air conditioner, a cleaner, an oven, a microwave oven, a washing machine, an air cleaner, a set-top box, a TV box (such as, Samsung HomeSync™, Apple TV™, or Google TV™), a game console, an electronic dictionary, an electronic key, a camcorder, and an electronic frame.

According to some embodiments, the electronic device may include at least one of the group consisting of various medical devices (such as, a magnetic resonance angiography (MRA) device, a magnetic resonance imaging (MRI) device, a computed tomography (CT) device, an image capturing device, and an ultrasonicator), a navigation device, a global positioning system (GPS) receiver, an event data recorder (EDR), a flight data recorder (FDR), a car infotainment device, electronic equipment for a ship (such as, a navigation device for a ship or a gyro compass), avionics, a security device, a head unit for a vehicle, an industrial or home robot, an automated teller machine (ATM) for financial institution, or a point of sales for a store.

According to some embodiments, the electronic device may include at least one selected from the group consisting of a portion of a building/structure or furniture including a configuration enabling computation, an electronic board, an electronic signature receiving device, a projector, and various metering devices (such as, water, electricity, gas and electric wave metering devices). The electronic device according to the present disclosure may be one of the above-described various devices or two or more combinations thereof. Moreover, the electronic device according to the present disclosure may be a flexible device. Also, it is obvious to a person skilled in that art that the electronic device according to the present disclosure is not limited to the above-described devices.

Electronic devices according to various embodiments are described below with reference to the accompanying drawings. The term “user” used in various embodiments may refer to a person who uses an electronic device, or a device (such as, an electronic device having artificial intelligence) that uses an electronic device.

FIG. 1 is a schematic diagram of an electronic device supporting a file processing function according to this disclosure. Referring to FIG. 1, an electronic device 100 according to an embodiment of the present disclosure may include a communication unit 110, an input unit 120, an audio processing unit 130, a display unit 140, a storage unit 150, and a control unit 160.

The electronic device 100 supports a non-security environment (or normal world, normal mode, or the like) and a security environment (or secure world, secure mode, or the like). In addition, the electronic device 100 supports the file processing function according to an input event or preset schedule information. For example, the electronic device 100 may store a normal file operating in the non-security environment in a secure region 153 related to the security environment. Also, the electronic device 100 may store a secure file operating in a security environment in a normal region 151 related to the non-security environment according to an input event. Accordingly, the electronic device 100 supports the file processing function that allows file sharing between the non-security environment and the security environment.

Even if a file stored in the secure region 153 is requested in the non-security environment in order to support the security function while the electronic device 100 supports the file processing function, the electronic device may not perform a corresponding request. According to various embodiments, the electronic device 100 may process a request for obtaining a file stored in the normal region 151 in the security environment.

The communication unit 110 may be included when the electronic device 100 has a communication function. Thus, when the electronic device 100 does not support the communication function, the communication unit 110 may be excluded from the electronic device 100 of the present disclosure. The communication unit 110 may form a communication channel with another electronic device or a server device. Alternatively, the communication unit 110 may include a communication module that may support a broadcast receiving function.

The communication unit 110 may receive at least one selected from the group consisting of various data, such as a normal file operating in the non-security environment or a secure file operating in the security environment, through the communication channel. The communication unit 110 may form a communication channel with another electronic device or a server device according to the operation of a normal app operating in the non-security environment (a normal application used in the non-security environment, which is referred to hereinafter as “normal app”), and receive a file through a corresponding communication channel. Also, the communication unit 110 may form a communication channel with another electronic device or a server device according to the operation of a secure app operating in the security environment (a secure application operating in the security environment, which is referred to hereinafter as “secure app”), and receive a file through a corresponding communication channel.

A file received by the communication unit 110 may be a document, still image or video data, sound data, or the like. The file received by the communication unit 110 may be stored in any one of the secure region 153 or normal region 151 of the storage unit 150 depending on the type of an app (application) in operation. For example, the file received by the communication unit 110 during the operation of the normal app may be stored in the normal region 151 of the storage unit 150. The file received by the communication unit 110 during the operation of the secure app may be stored in the secure region 153 of the storage unit 150.

The input unit 120 may perform an operation related to the generation of an input signal of the electronic device 100. For example, the input unit 120 may include various key buttons, such as a side key, a home key and a power key, or a keypad. Also, the input unit 120 may be provided in the form of a touch key. When the display unit 140 is provided by including a touch screen, the display unit 140 may operate as the input unit 120. The above-described input unit 120 may generate an input signal related to the non-security environment, an input signal related to the security environment, an input signal requesting for a change from the non-security environment to the security environment, and an input signal requesting for a change from the security environment to the non-security environment according to user control.

The input unit 120 may generate an input signal requesting for storing a specific normal file in the secure region 153 in the non-security environment and an input signal requesting for storing a specific secure file in the normal region 151 in the security environment. Also, the input unit 120 may generate an input signal requesting for storing, a specific normal file stored in the normal region 151, in the secure region 153, in the security environment. The above-described input signal may be generated in response to at least one selected from the group consisting of a specific key button select button, a touch event, a gesture event, and a sound event.

The electronic device 100 may include various sensor modules related to the generation of the gesture event. The sensor module may measure a physical quantity or sense the operation state of the electronic device 100 to convert measured or sensed information into an electrical signal. The sensor module may include at least one selected from the group consisting of a gesture sensor, a gyro sensor, an atmospheric pressure sensor, a magnetic sensor, an acceleration sensor, a grip sensor, a proximity sensor, a color sensor (such as, an RGB sensor), a bio sensor, a temperature/humidity sensor, an illumination sensor and an ultra violet (UV) sensor. Additionally or alternatively, the sensor module may include, for example, an E-nose sensor, an electromyography (EMG) sensor, an electroencephalogram (EEG) sensor, an electrocardiogram (ECG) sensor, an infrared (IR) sensor, an iris sensor or a fingerprint sensor. The sensor module may further include a control circuit for controlling at least one sensor that is included in the sensor module.

The electronic device 100 may use a microphone in the audio processing unit 130 regarding the generation of the sound event. The electronic device 100 may include a voice recognition algorithm and a voice recognition database (DB) to be capable of recognizing a voice signal collected by the microphone. Recognized voice information may operate as a sound event related to the file processing function according to an embodiment of the present disclosure.

The audio processing unit 130 may support the audio output function of the electronic device 100. The audio processing unit 130 may include at least one selected from the group consisting of a speaker, a receiver, an earphone, and a microphone. The audio processing unit 130 may output an audio signal generated according to the operation of a specific app of the electronic device 100. For example, the audio processing unit 130 may output an audio signal generated according to the operation of the normal app. Also, the audio processing unit 130 may output an audio signal generated according to the operation of the secure app.

According to an embodiment, when there is a request for storing, the normal file stored in the normal region 151, in the secure region 153 in the non-security environment, the audio processing unit 130 may output a voice message related to transferring a corresponding normal file and to storing the normal file in the secure region 153. In this case, the audio processing unit 130 may output the voice message requesting for the activation of the security environment when the security environment is in an inactivated state. Also, the audio processing unit 130 may output a voice message related to transferring a corresponding secure file and to storing the secure file when there is a request for storing the secure file of the secure region 153 in the normal region 151 in the security environment. Also, when there is a request for storing, the normal file stored in the normal region 151, in the secure region 153 in the security environment. The audio processing unit 130 may output a related voice message. Regarding the output of the voice message by the audio processing unit 130, the electronic device 100 may pre-store information on the voice message. The output of the voice message as described above may also be left out depending on a user setting or on the presence and absence of the support of the electronic device 100.

The display unit 140 may display various screens related to the operation of the electronic device 100. For example, the display unit 140 may display a standby screen, a menu screen, a screen on which at least one icon is arranged, a locked screen, or the like. According to an embodiment, the display unit 140 may display at least one selected from the group consisting of a non-security environment screen and a security environment screen. The non-security environment screen may include a non-security environment related standby screen and an activation screen of normal apps that may operate in the non-security environment. The security environment screen may include a security environment related standby screen and an activation screen of secure apps that may operate in the security environment. The display unit 140 may display a menu item or icon that may instruct a change from the non-security environment to the security environment, or a menu item or icon that may instruct a change from the security environment to the non-security environment in the above-described standby screen

The display unit 140 may display a screen related to an operation of transferring the normal file stored in the normal region 151 to the secure region 153, during the execution of the normal app. For example, the display unit 140 may display a list of normal files related to the normal file stored in the normal region 151 in the non-security environment. The display unit 140 may display a menu item or icon that may make a request for transmitting, at least one normal file selected from the list of normal files, to the secure region 153. The display unit 140 may display a normal file transfer progress screen and a screen representing that the storage of the normal file has in the secure region 153 been completed. In this example, the display unit 140 may display information requesting for the activation of the security environment when the security environment is in an inactivated stated. Also, the display unit 140 may display an authentication information input request screen for the activation of the security environment. The display unit 140 may display a list of secure folders including at least one storage region, storage or storage location related to the secure region 153, such as a folder in which the normal file is stored. When a specific folder is selected from the list of secure folders, a selected normal file may be stored in the secure region 153 of a corresponding folder location.

The display unit 140 may display a list of secure files related to the selection of a secure file stored in the secure region 153 in the security environment. The list of secure files may be provided through the execution of a secure app supporting the file processing function of the present disclosure. The display unit 140 may display a menu item or icon related to a secure file transfer request. When there is the secure file transfer request, the display unit 140 may display a screen showing a secure file transfer to the normal region 151 and a screen related to transfer completion. When a secure app not supporting the file processing function is performed, the list of secure files or a menu item or icon related to a file transfer request may not be provided. The display unit 140 may display at least one storage region, storage or storage location related to the normal region 151 in which the secure file is stored, such as a list of normal folders including a folder. When a specific folder is selected from the list of normal folders, a secure file may be stored in a selected normal folder.

According to claim an embodiment, the display unit 140 may display a list of normal files stored in the normal region 151 in the security environment according to a user request. For example, the display unit 140 may display a list of normal files related to a normal app on a security environment screen. The display unit 140 may display a screen moving or copying, at least one normal file selected from the list of normal files, to the secure region 153, according to a transfer request and a screen related to the completion of moving or copying. After the normal file is selected from the list of normal files, the display unit 140 may display a list of secure folders related to the secure region 153 in which the selected normal file is stored. When a specific secure folder is selected from the list of secure folders, the selected normal file may be moved or copied to a corresponding secure folder.

The above-described display 140 may include at least one of a capacitive touch panel, an electromagnetic induction touch panel and a resistive touch panel. The display unit 140 including a touch panel may operate as an input unit. A screen interface according to various embodiments of the present disclosure through the display unit 140 is described with reference to the drawings that are described below.

The storage unit 150 may store data and programs related to the operation of the electronic device 100. For example, the storage unit 150 may store the operating system (OS) of the electronic device 100. The storage unit 150 may store programs related to the specific function support of the electronic device 100, such as a web browser program, a broadcast receiving function support program, a camera operation program, and a game related program.

According to an embodiment, the storage unit 150 may include the secure region 153 storing according to a secure file system mode and the normal region 151 storing according to a normal file system mode. The normal region 151 may store at least one normal app operating in a non-security environment and a normal file related to the operation of the normal app. The normal app may be loaded on the control unit 160 to operate for normal user function support. The secure region 153 may store at least one secure app operating in a security environment and a secure file related to the operation of the secure app. The secure app may also be loaded on the control unit 160 to operate for security user function support in the security environment.

The storage unit 150 is not limited to a specific memory type or characteristic. For example, the storage unit 150 may include at least one selected from the group consisting of a volatile memory (such as a dynamic RAM (DRAM), a static RAM (SRAM), or a synchronous dynamic RAM (SDRAM)) and a non-volatile memory (such as an one time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory). Also, the storage unit 150 may be a solid state drive (SSD). The storage unit 150 may further include a flash drive, such as a compact flash (CF) drive, a secure digital (SD) drive, a micro secure digital (micro-SD) drive, a mini secure digital (mini-SD) drive, or an extreme digital (xD) drive, or a memory stick. According to an embodiment, the storage unit 150 may further include a storage device (or storage medium) such as an HDD. As described above, the storage unit 150 may be implemented in at least one of memory types having various characteristics. The normal region 151 and the secure region 153 may be provided on one chip and logically separated from each other in operation. Alternatively, the normal region 151 and the secure region 153 may also be provided in physically independent regions.

The control unit 160 may perform the transfer and processing of data related to the operation of the electronic device 100 and the transfer and processing of a control signal related to the operation. According to an embodiment, the control unit 160 may support a non-security environment based on data stored in the normal region 151. Also, the control unit 160 may support a security environment based on data stored in the secure region 153. The control unit 160 of the present disclosure may perform a series of file processing operations needed in a process of transferring a normal file stored in the normal region 151 to the secure region 153 according to a transfer request. Also, the control unit 160 may perform a series of file processing operations needed in a process of transferring a secure file stored in the secure region 153 to the normal region 151 according to a transfer request. According to an embodiment, the above-described normal file transfer processing may be performed in a non-security environment and the above-described secure file transfer processing may be performed in a security environment. Also, the control unit 160 may perform a series of file processing operations such as moving or copying normal files stored in the normal region 151 to the secure region 153 in the security environment.

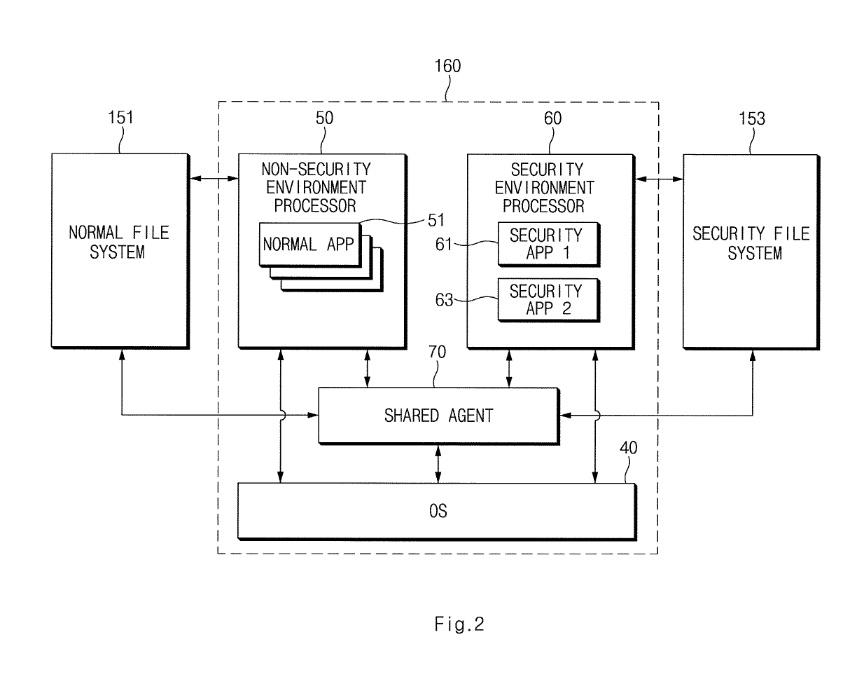

FIG. 2 is a diagram of example configurations of a storage unit and a control unit of file processing function related configurations according to this disclosure. Referring to FIG. 2, the control unit 160 may include a non-security environment processor 50 supporting a non-security environment, a security environment processor 60 supporting a security environment, a shared agent 70 and OS 40. The storage unit 150 may include the normal region 151 storing a normal file according to a normal file system mode and the secure region 153 storing a secure file according to a secure file system mode. The normal file may be a file on which an encryption process applied in a security environment has not been performed. The secure file may be a file encrypted according to the encryption process applied in the security environment. The normal file system applied to the normal file and the secure file system applied to the secure file may be mutually different in a defined method. Thus, a non-security environment processor 50 may not read or encode the secure file stored in the secure region 153, directly. Also, a security environment processor 60 may not read or encode the normal file stored in the normal region 151, directly.

The non-security environment processor 50 may perform information processing related to a non-security environment. For example, the non-security environment processor 50 may display a standby screen related to non-security environment support. The non-security environment processor 50 may load and execute at least one normal app stored in the normal region 1512. In this case, the non-security environment processor 50 may read and load from the normal region 151 data related to a normal app stored in the normal region 151, and process displaying a result of executing a corresponding normal app 51. The display unit 140 may display a screen by the activation of at least one normal app 51 by the non-security environment processor 50. The non-security environment processor 50 may support an icon display supporting a change to a security environment. The non-security environment processor 50 may call the security environment processor 60 when there is a request for a change to the security environment. When there is the change to the security environment, the non-security environment processor 50 may stand by in a background processing state or have a sleep state according to a pre-defined scheduling mode.

At least one normal app 51 executed by the support of the non-security environment processor 50 may support a file transfer function of a normal file related to itself during execution. For example, the normal app 51 may display an icon or menu item related to a file transfer during execution. When the icon or menu item is selected and a file transfer request event occurs while a specific normal file is selected, the normal app 51 may transfer at least one normal file transfer request to the shared agent 70.

The security environment processor 60 may perform information processing related to a security environment. The security environment processor 60 may process an operation for security environment support when there is a security environment activation request from the non-security environment processor 50. For example, the security environment processor 60 may display a standby screen related to security environment support. Thus, the display unit 140 may display a security environment standby screen according to a security environment change request while displaying a non-security environment standby screen.

The security environment processor 60 may load and execute at least one secure app 61 or 63 stored in the secure region 153. In this case, the security environment processor 60 may read and load data related to secure apps stored in the secure region 153 and display a result caused by the execution of corresponding secure apps 61 and 63. The display unit 140 may display a screen caused by the activation of at least one secure app 61 or 63 by the security environment processor 60

The security environment processor 60 may support an icon or menu item display supporting a non-security environment change. The security environment processor 60 may call the non-security environment processor 50 when there is a request for a change to the non-security environment. When there is the change to the non-security environment, the security environment processor 60 may transit to a turn-off state. Alternatively, the security environment processor 60 may stand by in a background processing state or have a sleep state. According to an embodiment, the security environment processor 60 may have a standby state or sleep state for a certain time and may transit automatically to the turn-off state after the certain time elapses.

At least one of secure apps 61 and 63 may support a file transfer function of a secure file related to itself during execution. For example, at least one of the secure apps 61 and 63 may display an icon or menu item related to a file transfer. When the icon or menu item is selected and a file transfer request event occurs while a specific secure file is selected, the secure apps 61 and 63 may transfer at least one secure file transfer request to the shared agent 70. According to an embodiment, at least one of the secure apps 61 and 63 may transfer a request for obtaining a normal file stored in the normal region 151 during execution to the shared agent 70. On the other hand, a specific secure app, such as a first secure app 61 or a second secure app 53 may be a secure app that does not support a file transfer function. In this case, when file migration to a secure region related to a secure app supporting the file transfer function, such as a specific folder related to a secure app is performed, the electronic device 100 may also support the file transfer function.

The shared agent 70 may control operations of migrating or copying at least one normal file stored in the normal region 151 to the secure region 153. The shared agent 70 may support a transfer of the normal file to the secure region 153 in a non-security environment by the operation of the non-security environment processor 50. The shared agent 70 may directly read a selected normal file from the normal region 151 and store a read file in a certain region of the secure region 153, such as a pre-defined specific folder location. To this end, the shared agent 70 may be designed to have both read and write rights with respect to the normal region 151 and the secure region 153. The shared agent 70 may support a function of converting the normal file so that the file is suitable for a secure file system. The shared agent 70 may request the security environment processor 60 to activate a security environment when the security environment is in an inactivated state in the process of transferring the normal file. Regarding this matter, the shared agent 70 may call the security environment processor 60.

According to various embodiments, the shared agent 70 may receive a selected normal file from the non-security environment processor 50 and transfer it to the security environment processor 60. In this case, the shared agent 70 may be designed to perform a file transfer function between the non-security environment processor 50 and the security environment processor 60. According to various embodiments, the shared agent 70 may receive a selected normal file from the non-security environment processor 50 and store it in the secure region 153. In this case, the shared agent 70 may be designed to have write access to the secure region 153 and may directly store a normal file received from the non-security environment processor 50 in the secure region 153. The shared agent 70 may support a function of converting the normal file so that the file is suitable for a secure file system of the secure region 153. Alternatively, by transferring a secure file to the non-security environment processor 50 or a processor module managing the normal region 151 of the storage unit 150 by the shared agent 70, the electronic device 100 may convert a secure file into a normal file so that the secure file is suitable for a normal file system, and may then store the normal file.

The shared agent 70 may control operations of migrating or copying at least one secure file stored in the secure region 153 to the normal region 151. In this case, the shared agent 70 may support a secure file transfer while a security environment operates by the activation of the security environment processor 60. The shared agent 70 may directly read a selected secure file from the secure region 153 and store a read file in a certain region of the normal region 151, such as a pre-defined specific folder location. To this end, the shared agent 70 may be designed to have both read and write rights with respect to the normal region 151 and the secure region 153. The shared agent 70 may support a function of converting the secure file so that the file is suitable for a normal file system of the normal region 151.

According to various embodiments, the shared agent 70 may receive a selected secure file from the security environment processor 60 and transfer a received file to the non-security environment processor 50 so that a file in the secure region 153 is stored in the normal region 151. According to various embodiments, the shared agent 70 may receive a selected normal file from the security environment processor 60 and store it in the normal region 151. In this case, the shared agent 70 may be designed to have write access to the normal region 151 and may directly store a normal file received from the security environment processor 50 in the normal region 151. The shared agent 70 may support a function of converting the secure file so that the file is suitable for a normal file system of the normal region 151.

According to various embodiments, the shared agent 70 may display a list of normal files stored in the normal region 151 on a security environment screen while a security environment is activated. Alternatively, the shared agent 70 may display the list of normal files on a specific secure app operation screen being executed in the security environment. When at least one of the list of normal files is selected and there is a request for obtaining it, the shared agent 70 may migrate a selected normal file from the normal region 151 to the secure region 153 or copy it thereto. In this case, the shared agent 70 may convert a file system mode for the normal file into a secure file system mode and store a new file obtained through conversion. Alternatively, the shared agent 70 may transfer a normal file to the security environment processor 60 or a processor module managing the secure region 153, and the secure region 153 management processor may convert a received normal file so that the file is suitable for the secure file system and then store a new file obtained through conversion.

The OS 40 may support the operations of the non-security environment processor 50, the security environment processor 60 and the shared agent 70. For example, the OS 40 may support the activation of a non-security environment by the operation of the non-security environment processor 50 when power is supplied to the electronic device 100. In addition, when a change to a security environment is requested, the OS 40 may support the activation of the security environment by the operation of the security environment processor 60.

According to various embodiments of the present disclosure as described above, the electronic device 100 according to an embodiment of the present disclosure may include the storage unit 150 including a normal region storing a normal file related to a function operating in a non-security environment and a secure region storing a secure file related to a function operating in a security environment, and the control unit 160 reading the normal file stored in the normal region in response to a file transfer request in the non-security environment to write a read file to the secure region, or reading the secure file stored in the secure region in the security environment to write a read file to the normal region.

The control unit may allow the normal file to be migrated or copied to the secure region depending on the type of the file transfer request or allow the secure file to be migrated or copied to the normal region in response to the file transfer request.

According to various embodiments, the control unit may include a non-security environment processor supporting the non-security environment, a shared agent supporting the migration or copying of the normal file in the normal region to the secure region and the migration or copying of the secure file in the secure region to the normal region, and a security environment processor supporting the security environment.

According to various embodiments, the shared agent may have normal file read and write rights with respect to the normal region and secure file read and write rights with respect to the secure region. In addition, the shared agent may receive a normal file storage location to be transferred from the non-security environment processor when there is the normal file transfer request, directly read a file from the normal region and then write the file to the secure region directly. Also, the shared agent may receive a secure file storage location to be transferred from the security environment processor when there is the secure file transfer request, directly read a file from the secure region and then write the file to the normal region directly.

According to various embodiments, the shared agent may receive the normal file from the non-security environment processor when there is the normal file transfer request, and transfer a received file to a processor managing the reading and writing of the secure region.

According to various embodiments, when there is the secure file transfer request, the shared agent may request a processor managing the reading and writing of the secure region to read the secure file to be transferred and collect a decrypted secure file.

According to various embodiments, the shared agent may check the activation of the security environment when there is the normal file transfer request, and call the security environment process to activate an inactivated security environment.

According to various embodiments, the electronic device 100 of the present disclosure may further include the display unit 140 that displays at least one of a screen for selecting the normal file in the normal region, a screen for selecting the folder location in the secure region to store a selected normal file, a screen for selecting the secure file in the secure region, and a screen for selecting the folder location in the normal region to store a selected secure file.

According to various embodiments, the control unit 160 may allow the normal file to be stored in the secure region related to the secure app similar to the normal app related to the selected normal file, such as a folder in the secure region or allow the secure file to be stored in the normal region related to the normal app similar to the secure app related to the selected secure file, such as a folder in the normal region.

According to various embodiments, the control unit 160 may allow the normal file to be stored by default in the normal region related to a specified normal app, such as a folder when there is no similar normal app, or allow the secure file to be stored in the secure region related to a pre-specified secure app, such as a folder when there is no similar secure app.

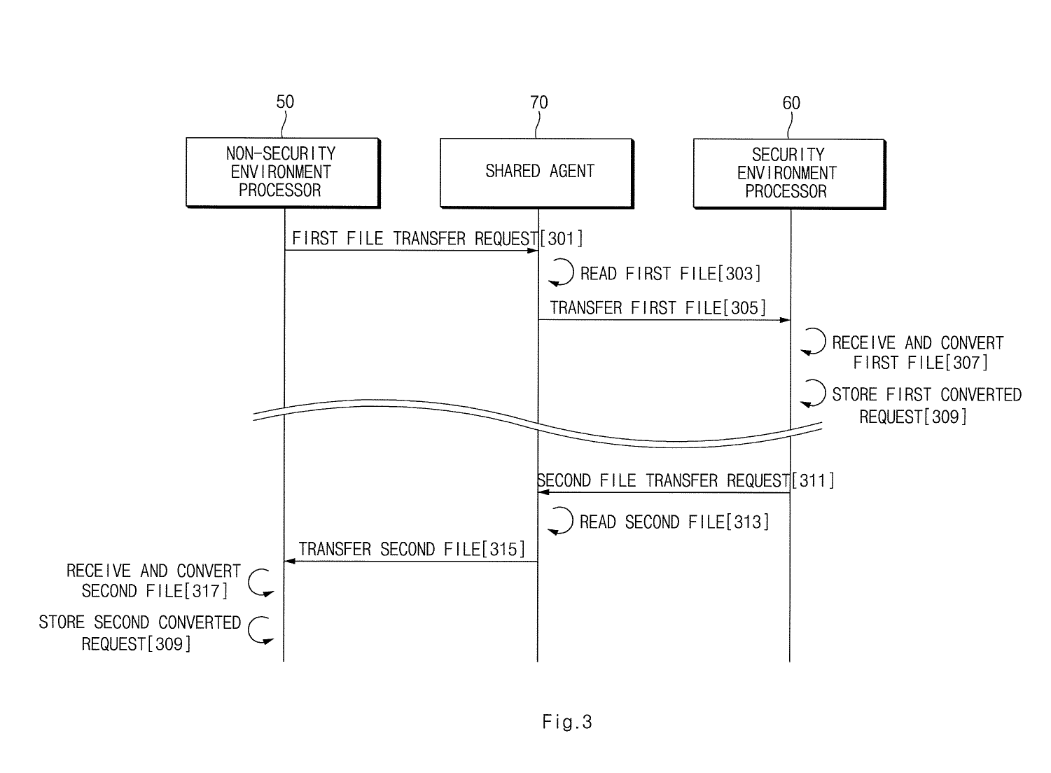

FIG. 3 is a diagram illustrating an example transmission and reception of a file processing function related signal according to this disclosure. Referring to FIG. 3, the non-security environment processor 50 may perform a first file transfer request in operation 301. According to an embodiment, the electronic device 100 may display a non-security environment standby screen by the operation of the non-security environment processor 50. The non-security environment processor 50 may activate the normal app 51 by the occurrence of an input event requesting the activation of the normal app 51. The normal app 51 may support, for example, a gallery function. Thus, the display unit 140 may display a gallery execution screen including at least one photo file.

The display unit 140 may display a menu item or icon enabling a file transfer request. Regarding the function of the normal app 51, when a menu item related to a file transfer request is selected after at least one first file stored in the normal region 151 is selected, the non-security environment processor 50 may transfer selected first file information and the file transfer request to the shared agent 70. Alternatively, the non-security environment processor 50 may perform a first file selection process to be transferred when a menu item related to the file transfer request is selected. In this process, the non-security environment processor 50 may display a list of files in a folder related to the normal app 51 on the display unit 140. Then, a user may perform an input operation for selecting at least one first file among the list of files. Also, the non-security environment processor 50 may display at least one of specific locations in the secure region 153 on the display unit 140. For example, the non-security environment processor 50 may provide folder locations related to a gallery app or file manager app operating by the security environment processor 60. On the other hand, the storage location of a file transferred in the file processing function may be set by default. For example, the file transferred from the normal region 151 may be automatically stored in a folder location related to the file manager app. Also, the file transferred from the secure region 153 may be automatically stored in a folder location, such as a file manager app or gallery app.

When the first file to be transferred is selected, the non-security environment processor 50 may transfer selected file information and a file transfer request to the shared agent 70. In this case, the non-security environment processor 50 may transfer, to the shared agent 70, location information in the normal region 151 in which a selected first file is stored. Alternatively, the non-security environment processor 50 may directly read the first file stored in the normal region 151 and transfer a read file to the shared agent 70.

The shared agent 70 may read the first file in operation 303. The shared agent 70 may check normal region 151 location information on the first file from the non-security environment processor 50. In addition, the shared agent 70 may directly read the first file from the normal region 151. On the other hand, when an embodiment is designed such that the non-security environment processor 50 directly transmits first file data, operation 303 may be replaced with the process of receiving the first file data.

The shared agent 70 may transfer the first file in operation 305. The shared agent 70 may transfer the first file data read or received to the security environment processor 60. In this case, the shared agent 70 may request the activation of the security environment when the security environment is in an inactivated state. In response to a security environment activation request, the security environment processor 60 may operate so that a program for the security environment is executed. In this case, the security environment processor 60 may process an operation related to an authentication information input when a user authentication process is set.

When the security environment is in an activated state, the security environment processor 60 may receive and convert the first file that the shared agent 70 has transferred, in process 307. The security environment processor 60 may convert the first file transferred by the shared agent and having a normal file system into a first converted file that may be stored in the secure region 153. For example, the security environment processor 60 may encrypt the first file to have a format that may be stored in the secure region 153. The security environment processor 60 may store the first converted file in the secure region 153 in operation 309. Regarding this process, the security environment processor 60 may operate an encryption module and decryption module related to storing or reading data in or from the secure region 153.

According to various embodiments, the encryption module or decryption module related to the secure region 153 may be designed such that the shared agent 70 may include or access the modules. Then, operations 307 and 309 may be replaced with the process of using the encryption module to convert the first file into the first converted file by the shared agent and storing the first converted file obtained through conversion in the secure region 153.

The shared agent 70 may store the first converted file in a pre-defined specific location when storing the file in the secure region 153. According to an embodiment, the shared agent 70 may store the first converted file in a folder location related to a specific app operating by the security environment processor 60, such as a file manager app, by default. Alternatively, the shared agent 70 may check a normal app related to the first file selected by the non-security environment processor 50 and store the first converted file in a folder location related to a secure app of a similar type to the normal app. The shared agent 70 may first search for a secure app of a similar type to the normal app and store the first converted file in a folder location related to a pre-designated specific secure app by default when there is no similar app.

The security environment processor 60 may transfer a second file transfer request to the shared agent 70 in operation 311. Regarding this, the electronic device 100 may have a security environment processor 60 based security environment state. In this case, the electronic device 100 may have a standby state or sleep state in a non-security environment. Alternatively, the electronic device 100 may have a security environment state in response to a request for a change from the non-security environment to the security environment. The security environment processor 60 may display a screen related to at least one secure app 61 or 63 in the security environment. Alternatively, the security environment processor 60 may display a security environment standby screen on which an icon related to at least one secure app 61 or 63 is disposed.

When the activation of the specific secure app 61 or 63 supporting the file processing function is requested, the security environment processor 60 may display a corresponding secure app 61 or 63 activation screen on the display unit 140. For example, when a file manager app is activated in the security environment, a list of secure files related to a file manager stored in the secure region 153 may be displayed on the display unit 140. The display unit 140 may display an icon or menu item related to a file transfer request in the security environment. When a second file corresponding to at least one secure file is selected and there is the file transfer request, the security environment processor 60 may transfer the second file transfer request to the shared agent 70. In this case, the security environment processor 60 may transfer, to the shared agent 70, location information on the secure region 153 in which the second file is stored.

The shared agent 70 may read the second file in operation 313. The shared agent 70 may check secure region 153 location information transferred by the security environment processor 60 and read the second file stored in a corresponding secure region 153 location. To this end, the shared agent 70 may have access to an encrypted file stored in the secure file 153 and a file decryption function. When the second file is read, the shared agent 70 may transfer the second file in operation 315.

When the second file is transferred from the shared agent 70, the non-security environment processor 50 may receive and covert the second file in operation 317. The non-security environment processor 50 may convert the second file to have a format that may be stored in the normal region 151. In addition, the non-security environment processor 50 may store a second converted file in operation 319.

According to various embodiments, the shared agent may convert the second file to have a format that may be stored in the normal region 151. Then, the shared agent 70 may write the second converted file directly to the normal region 151.

On the other hand, the shared agent 70 may request a processor managing the secure region 153 to read the second file in the process of reading the second file. Then, the processor managing the secure region 153 may read the second file stored in a specific location from the secure region 153 in response to a request from the shared agent 70 to perform a decryption process. Thus, the second file transferred to the shared agent 70 may have a file format on which decryption has been completed.

The shared agent 70 may store the second converted file in a folder location related to a pre-defined specific normal app by default. Alternatively, the shared agent 70 may search for a normal app similar to a secure app executed when there is the second file transfer request, and store the second converted file in a folder location related to a corresponding normal app. In this example, the shared agent may store the second converted file in the folder location related to the pre-defined specific normal app when there is no normal app similar to the secure app.

The file processing function according to an embodiment of the present disclosure as described above may be designed in various forms depending on functions possessed by the shared agent 70, such as direct access rights to the normal region 51 and the secure region 153 and a direct data reading or writing function. Thus, the file processing function according to an embodiment of the present disclosure may transfer a file through the non-security environment processor 50 or the security environment processor 60 or process the file based on storage location information on the file transferred from the non-security environment processor 50 and the security environment processor 60.

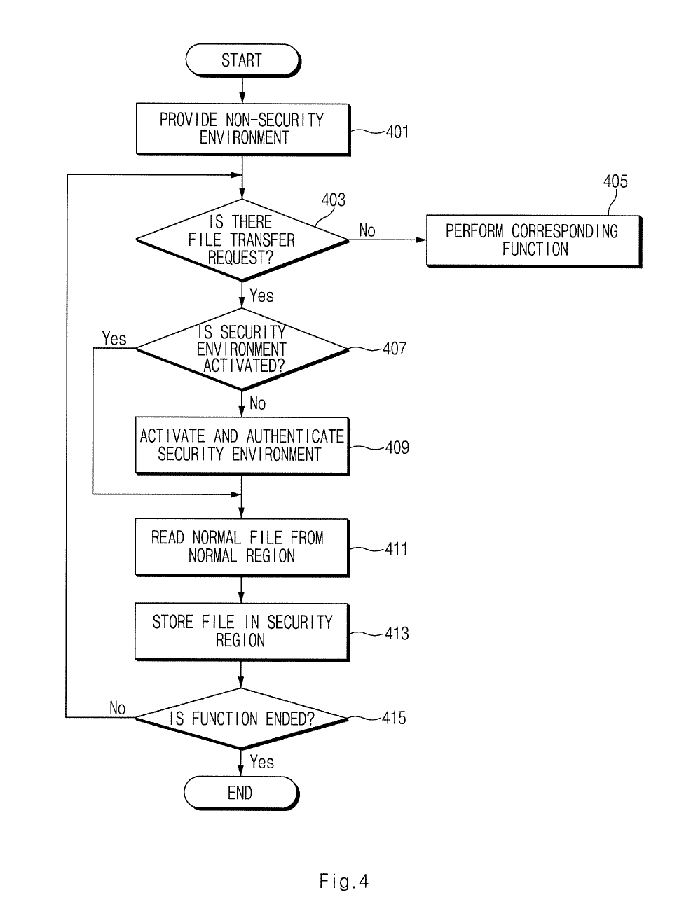

FIG. 4 is a diagram illustrating an example file processing method in a non-security environment according to this disclosure. Referring to FIG. 4, the control unit 160 may provide a non-security environment in operation 401. For example, when power is supplied, the control unit 160 may load OS and operate in the non-security environment by the operation of the OS. In the non-security environment, the control unit 160 may display a standby screen on which at least one icon related to a normal app is disposed. Alternatively, the control unit 160 may execute a specific normal app according to pre-defined schedule information and display a normal app execution screen. The control unit 160 may allow an icon or menu item related to performing the file processing function according to an embodiment of the present disclosure to be displayed on the display unit 140. On the other hand, the electronic device 100 may request a change to the non-security environment during the security environment so that the security environment is transited to a standby state or sleep state, and have a non-security environment.

When a specific event occurs, the control unit 160 may check whether the event is an event related to a file transfer request in the non-security environment, in operation 403. When the event which has occurred in operation 403 is an event irrelevant to the file transfer request, the control unit 160 may control a function depending on the type or characteristic of a corresponding event in operation 405. For example, the control unit 160 may control a function of a normal app being currently executed in response to the event. Alternatively, the control unit 160 may execute another normal app or end the normal app being currently executed.

When an event related to the file transfer request occurs in operation 403, the control unit 160 may check whether the security environment is in an activated state, in operation 407. When a normal file is selected and there is the file transfer request, the control unit 160 may provide at least folder location included in the secure region 153. In this example, the folder may also include a folder in which a file represented on the standby screen in the security environment or the wallpaper is disposed, in addition to a folder related to a specific secure app. A user may select a folder in the secure region 153 to store a selected normal file or may drag the selected normal file and drop a dragged file into a specific folder location so that the location of the secure region 153 to store the normal file may be designated.

When the security environment is not in the activated state in operation 407, the control unit 160 may activate the security environment in operation 409. When the security environment is in the activated state in operation 407, the control unit 160 may skip operation 409. For example, when a change to a non-security environment is requested to change the security environment to a standby state or sleep state while the security environment is in the activated state, the security environment activation process may be skipped.

In operation 411, the control unit 160 may read a selected normal file among normal files stored in the normal region 151. For example, the shared agent 70 of the control unit 160 may read the selected normal file from the normal region 151. In this case, the shared agent 70 may request a processor controlling data reading from and data writing to the normal region 151 to read a corresponding normal file. In this example, the selected normal file may be a file selected by the event that has occurred in file transfer request operation 403.

The shared agent 70 of the control unit 160 may allow the normal file read in operation 413 to be stored in the secure region 153. In this case, the shared agent 70 may convert the normal file so that the file is suitable for a secure file system of the secure region 153, and then directly store a converted normal file. Alternatively, the shared agent 70 may request a processor managing reading from and writing to the secure region 153 to store the normal file. Then, the secure region 153 management processor may convert, such as, encrypt a transferred normal file to be suitable for the secure region 153, and store a converted file.

In operation 415, the control unit 160 may check whether there is a function end related event. When there is no function end related event, the control module 160 may return to operation 403 to re-perform related processes. The control unit 160 may end a function when there is the function end related event. In addition, the control unit 160 may allow the electronic device 100 to transit to a sleep state, a specific normal app execution state, or a standby screen state.

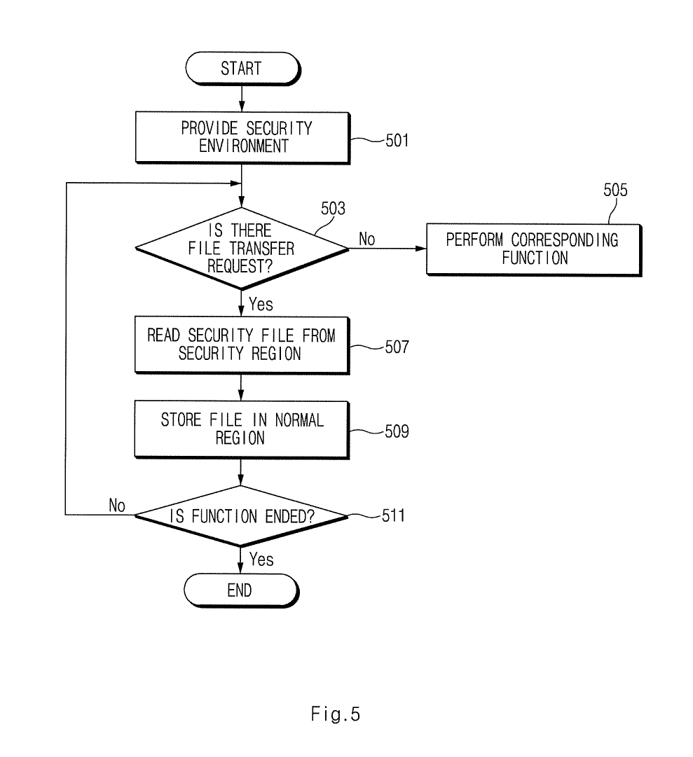

FIG. 5 is a diagram illustrating an example file processing method in a security environment according to this disclosure. Referring to FIG. 5, the control unit 160 may control security environment execution in operation 501. For example, the control unit 160 may perform execute a non-security environment after the turning-on of the electronic device 100 and perform a security environment according to a user request. In this case, the non-security environment may be transit to a standby state or sleep state. Alternatively, the control unit 160 may also control the security environment execution after non-security environment execution according to set schedule information.

When a specific event occurs, the control unit 160 may check whether the event is an event related to a file transfer request in the security environment, in operation 503. The control unit 160 may support the displaying of an icon or menu item related to a file transfer request in the security environment. When the event is not a file transfer request related event, the control unit 160 may proceed to operation 505 to perform a function corresponding to a corresponding event. For example, control unit 160 may control specific secure app execution in response to the event which has occurred, or control a change to a non-security environment.

When the file transfer request related event occurs in operation 503, the control unit 160 may read a secure file from the secure region 153 in operation 507. For example, the control unit 160 check whether at least one secure file is selected in a specific secure app execution process and an icon or menu item for a transfer request for a selected secure file is selected. When the file transfer request related event occurs, the control unit 160 may check a location in the secure region 153 in which the secure file corresponding to the event which has occurred is stored. In addition, the control unit 160 may transfer location information on the secure file to the shared agent 70. In this case, the control unit 160 may also transfer location information together to be stored in the normal region 151 to the shared agent 70. Regarding this, when a secure file is selected and there is the file transfer request, the control unit 160 may provide at least folder location included in the normal region 151. In this example, the folder may also include a folder in which a file represented on a standby screen or the wallpaper is disposed, in addition to a folder related to a specific normal app. A user may select a folder in the normal region 151 to store a selected secure file or may drag the selected secure file and drop a dragged file into a specific folder location so that a location in the normal region 151 to store the secure file may be designated. In the process of reading the secure file from the secure region 153, a processor managing the secure region 153 may decrypt the secure file during the reading of a corresponding secure file. Thus, the secure file read from the secure region 153 may have a decrypted file format.

The control unit 160 may store the secure file in the normal region 151 in operation 509. In this case, the control unit 160 may operate at least one of the shared agent 70 or the non-security environment processor 50. According to an embodiment, the shared agent 70 may allow the secure file received from the security environment processor 60 to be directly written to a certain location in the normal region 151. In this case, the shared agent 70 may request a processor managing reading from and writing to the normal region 151 of the storage unit 150 to store a corresponding secure file. Alternatively, the shared agent 70 may also transfer the secure file to the non-security environment processor 50 to request the processor to store a corresponding file in the normal region 151.

In operation 511, the control unit 160 may check whether there is a function end related event. When there is no function end related event, the control module 160 may return to operation 503 to re-perform related processes. When the function end related event occurs, the control unit 160 may transit the state of the electronic device 100 to a sleep state, a specific secure app execution state, a security environment standby screen display state, or the like. Alternatively, the control unit 160 may also end the security environment according to the event which has occurred, and change to a non-security environment.

According to the descriptions above, various embodiments of the present disclosure may disclose the file processing method that includes providing a non-security environment or security environment and storing a file including reading the normal file from the normal region related to the non-security environment during the execution of the non-security environment to write a read file to the secure region related to the security environment, reading the secure file stored in the secure region in the security environment to write a read file to the normal region, or reading the normal file from the normal region in the security environment to write a read file to the secure region.

The process of storing may be a process of migrating or copying the normal file the secure file, according to a file transfer request type.

According to various embodiments, the process of storing may include the processes of: receiving the stored location of the normal file from the non-security environment processor supporting the non-security environment by the shared agent, reading the normal file from the normal region by the shared agent, and using a processor managing reading from and writing to the secure region to store the normal file in the secure region by the shared agent.

According to various embodiments, the process of storing may include the processes of: receiving the normal file from the non-security environment processor supporting the non-security environment by the shared agent, transferring the normal file to the security environment processor supporting the security environment by the shared agent, and storing the normal file in the secure region by the security environment processor.

According to various embodiments, the process of storing may include the processes of: receiving the stored location of the secure file from the security environment processor supporting the security environment by the shared agent, using a processor managing reading from and writing to the secure region to obtain a decrypted secure file by the shared agent, and storing a decrypted secure file in the normal region by the shared agent.

According to various embodiments, the process of storing may include the processes of: receiving a decrypted secure file to be transferred from the security environment processor supporting the security environment by the shared agent, and storing the secure file in the normal region by the shared agent.

According to various embodiments, the process of storing may further include the processes of checking the activation of the security environment when there is the normal file transfer request, and activating the security environment when the security environment is in an inactivated state.

According to various embodiments, the method may further include at least one of the processes of: displaying a screen including a file icon corresponding to at least one normal file related to the operation of a specific normal app in the non-security environment, displaying a menu item for requesting the migration or copying of the normal file, and displaying a list of folders in the secure region to store the normal file when there is the file migration or copying request or displaying a folder in the secure region to store the normal file by default when there is the file migration or copying request.

According to various embodiments, the method may further include at least one of the processes of: displaying a screen including a file icon corresponding to at least one secure file related to the operation of a specific secure app in the security environment, displaying a menu item for requesting the migration or copying of the secure file, and displaying a list of folders in the normal region to store the secure file when there is the file migration or copying request or displaying a folder in the normal region to store the secure file when there is the file migration or copying request.

According to various embodiments, the method may further include at least one of the processes of: displaying a list of normal files to be transferred through a request in the security environment, displaying a menu item for requesting the migration or copying of the normal file, and displaying a list of folders for the folder selection of the secure region to store the normal file or displaying a specific folder in the secure region to store by default.

According to various embodiments, the process of storing may further include at least one of the processes of: storing the normal file in a folder in a secure app similar to a normal app related to a selected normal file, storing the secure file in a folder related to a pre-defined secure app when there is no similar secure app, storing the secure file in a folder in a normal app similar to a secure app related to a selected secure file, and storing the normal file in a folder related to a specified normal app by default when there is no similar normal app.

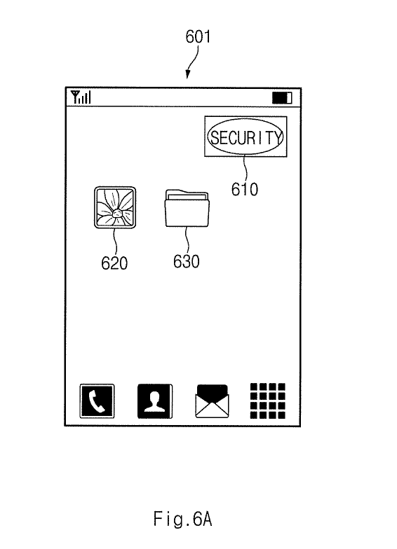

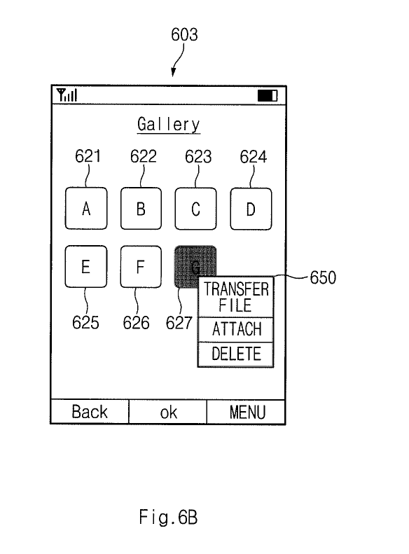

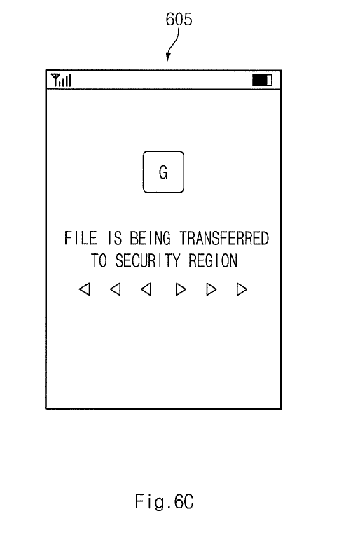

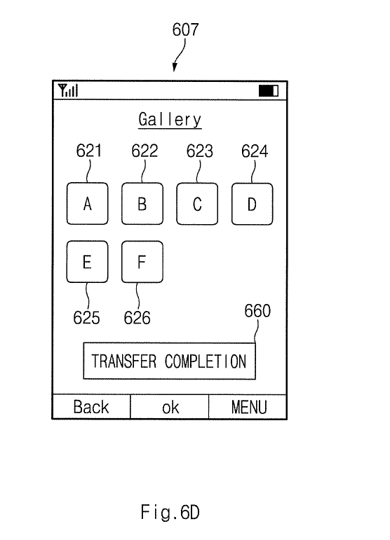

FIGS. 6A, 6B, 6C, and 6D are diagrams illustrating example file processing related screen interfaces in a non-security environment according to this disclosure. Referring to FIGS. 6A, 6B, 6C, and 6D, the display unit 140 of the electronic device 100 may display a non-security environment standby screen, such as screen 601 depicted in FIG. 6A in response to a non-security environment execution request by the operation of the non-security environment processor 50. The non-security environment standby screen may include at least one normal app icon 620 or 630 and a first mode change icon 610, for example. The first mode change icon 610 may be an icon requesting a change to a security environment. When the first mode change icon 610 is selected, the control unit 160 may change to the security environment. In this case, when the security environment is in an inactivated state, the control unit 160 may process security environment execution.

The normal app icons 620 and 630 may be icons for executing various apps capable of operating in the non-security environment, such as a game web, weather app, messaging app, an alarm app, and camera app. In the screen 601 depicted in FIG. 6A, the normal app icons 620 and 630 may correspond to a gallery function app and a file manager function app, for example. When there is a request for executing the gallery function app icon 620 of the normal app icons 620 and 630, the display unit 140 may display a gallery app execution screen as in the screen 603 depicted in FIG. 6B by gallery app execution. The gallery app execution screen may include file identifiers, such as file icons 621 to 627, corresponding to at least one normal file stored for a gallery function.

As shown in FIG. 6B, when a file G icon 627 of the file icons 621 to 627 is selected, the display unit 140 may display a first list of functions 650 related to a selected file G icon 627. The first list of functions 650 may include a file transfer item. The file transfer item may be an item requesting a transfer of a normal file G corresponding to the file G icon 627 stored in the non-security environment to the security environment. Furthermore, when a file transfer item is selected, the display unit 140 may display at least one folder item related to the secure region 153. The folder item may include at least one folder related to a secure app in the secure region 153. When the folder item does not exist or is not selected, a selected normal file may be stored in a specific location in the secure region 153 defined by default.

When the file transfer item on the first list of functions 650 is selected, the shared agent 70 of the control unit 160 may read a normal file G corresponding to the file G icon 627 selected in the normal region 151 and migrate or copy the file to the secure region 153. In this case, the display unit 140 may display a screen related to the migration or copying of the normal file G as shown in the screen 605 depicted in FIG. 6C. A selected normal file G is transferred, the display unit 140 may display a file transfer result screen as shown in the screen 607 depicted in FIG. 6D. The display unit 140 may display a transfer completion message 660 on a result of migrating the normal file G and remove the file G icon 627 corresponding to the normal file G from the gallery app execution screen. In addition, the display unit 140 may display file icons 621 to 626 corresponding to normal files excluding the file G icon 627. When the normal file G is transferred through copying, the file G icon 627 may maintain a display state in the screen 607 depicted in FIG. 6D.

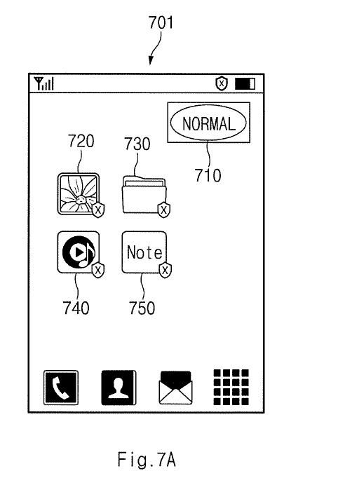

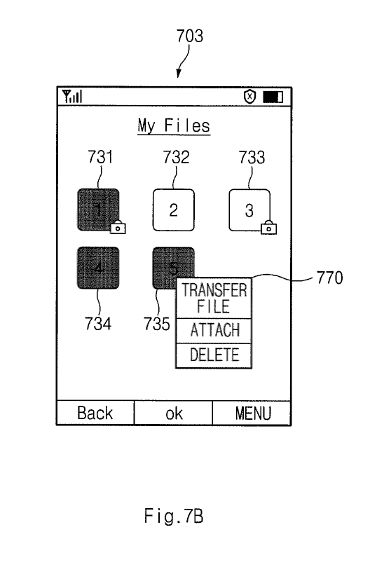

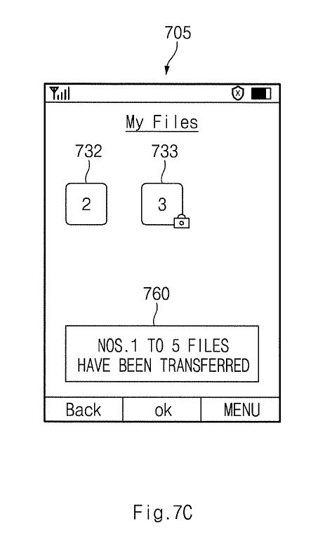

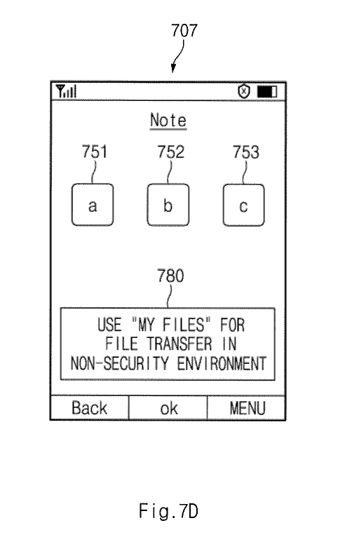

FIGS. 7A, 7B, 7C, and 7D are diagrams illustrating example file processing related screen interfaces in a security environment according to this disclosure. Referring to FIGS. 7A, 7B, 7C, and 7D, the display unit 140 of the electronic device 100 may display a security environment standby screen, such as the screen 701 depicted in FIG. 7A in response to a security environment execution request. The security environment standby screen may include at least one secure app icon 720, 730, 740 or 750 and a second mode change icon 710, for example. The second mode change icon 710 may be an icon requesting a change to a non-security environment. When the second mode change icon 710 is selected, the control unit 160 may change to the non-security environment. In this case, the control unit 160 may transit the security environment to a standby state or a sleep state.

The secure app icons 720 to 750 may be icons that indicate apps capable of operating in the security environment, such as a messaging app, alarm app, and note function app. According to an embodiment, the secure app icons 720 to 750 may include a security gallery function icon 720, a secure file manager function icon 730, a security video play function icon 740, and a security note function icon 750. When the secure file manager function icon 730 of the secure app icons 720 to 750 is selected to execute the secure file manager function, the display unit 140 may display a secure file manager function execution screen as shown in the screen 703 depicted in FIG. 7B. The secure file manager function execution screen may represent at least one secure file 731, 732, 733, 734 or 735 managed by the secure file manager among specific files operating in the security environment.

When a first file icon 731, a fourth file icon 734, and a fifth file icon 735 among the secure file icons 731 to 735 corresponding to the secure files are selected, the control unit 160 may display a second list of functions 770 that may be performed based on selected files. The second list of functions 770 may include items, such as an attach function, delete function, and file transfer function that are based on selected files. In this example, the control unit 160 may also display the second list of functions 770 when a menu item is selected after the selection of a file. The control unit 160 may control a transfer of selected files to the normal region 151 when the file transfer item is selected from the second list of functions 770. On the other hand, when the file transfer item is selected from the second list of functions 770, the display unit 140 may display a folder selection screen of the normal region 151 to store secure files corresponding to selected file icons 731, 734 and 735. When there is no separate folder designation, the control unit 161 may allow selected files to be stored in a specific folder in the normal region 151 defined by default. In this process, the security environment processor 60 of the control unit 160 may transfer secure region location information to the shared agent 70 for the reading operation of the selected files.

When a transfer of the selected files is completed, the display unit 140 may display a screen including remaining file icons 732 and 733 excluding transferred files as shown in the screen 705 depicted in FIG. 7C. In addition, the display unit 140 may display a message 760 providing a notification that a file transfer has been completed. The second list of functions 770 may further include a file copy item. When the first file icon 731, the fourth file icon 734 and the fifth file icon 735 are transferred to the normal region 151 based on the file copy item, the display unit 140 may also maintain the screen 703 depicted in FIG. 7B on which all the files are disposed.

On the other hand, when the security note function icon 750 is selected in the screen depicted in FIG. 7A, the electronic device 100 may perform the activation of a note function in the security environment. The electronic device 100 may display a screen including the security note file icons 751 to 753 by the activation of the security note function as shown in the screen 707 depicted in FIG. 7D. On the other hand, the security note function may not support a file transfer to the normal region 151. Thus, the display unit 140 may display a message 780 providing a related notification. Alternatively, in the process of displaying a list of functions after the selection of a specific file, the file transfer item or the file copy item may not be selected. Alternatively, when the file transfer item or the file copy item is selected, the display unit 140 may display the message 780. When there is a need for files related to the security note function to transferred to the normal region 151, a user may copy or migrate security note function related files to a folder related to a function capable of transferring a file, such as a secure file manager function. In addition, the user may transfer a corresponding security note function related file to the normal region 151 based on the secure file manager function.

As described above, the file processing method and the electronic device supporting the method of the present disclosure may allow the file stored in the normal region and the file stored in the secure region to operate in the non-security environment or security environment and may also maintain a security characteristic.

Each of the above-described elements of the electronic device according to the present disclosure may include one or more components and the names of corresponding elements may vary depending on the type of an electronic device. The electronic device according to the present disclosure may include at least one of the above-described elements and some elements may be left out or other elements may be further included. Also, some of the elements of the electronic device according to the present disclosure are combined to form an entity, which may equally perform the functions of corresponding elements before being combined.

The term “unit” used in the communication unit or the like of the present disclosure may mean a unit including one of hardware, software and firmware, or a combination of two or more thereof, for example. The “unit” may be interchangeably used with the term “module”, “logic”, “logical block”, “component”, or “circuit”, for example. The “unit” may be an elementary unit of or a portion of an integral component. The “unit” may also be an elementary unit for performing one or more functions or a portion of the elementary unit. The “unit” may be implemented mechanically or electronically. For example, the “unit” according to the present disclosure may include at least one selected from the group consisting of an application-specific integrated circuit (ASIC) chip, a field-programmable gate array (FPGA) and a programmable-logic device performing some operations that have been known or will be developed.

According to various embodiments, at least some of devices (such as units or their functions) or methods (such as operations) according to the present disclosure may be implemented as commands stored in a computer-readable storage medium in the form of a programming module, for example. When the command is executed by one or more processors (such as processors 50 and 60), the one or more processors may perform a function corresponding to the command. The computer readable storage medium may be the storage unit 150, for example. At least a portion of the programming module may be implemented (such as, performed) by a processor, for example. At least a portion of the programming module may include such as, a module, program, routine, set of instructions or process for executing one or more functions.

The computer readable recording medium may include a magnetic medium such as a hard disk, a floppy disk and a magnetic tape, an optical medium such as a compact disk read only memory (CD-ROM) and a digital versatile disc (DVD), a magneto-optical medium such as a floptical disk, and a hardware device that is especially configured to store and execute a program command (such as a programming module), such as a read only memory (ROM), a random access memory (RAM), and a flash memory. Also, the program command may include a machine code made by a compiler as well as a high-level language code that may be executed by a computer by using an interpreter. The above-described hardware device may be configured to operate by one or more software modules to execute the operations of the present disclosure and vice versa.

A module according to the present disclosure or a programming module may include at least one selected from the group consisting of the above-described elements and some elements may be left out or other elements may be further included. Operations executed by a module according to the present disclosure, a programming module or another element may be executed by using a sequential, parallel, repetitive or heuristic method. Also, the execution order of some operations may vary, some operations may be left out or further operations may be added.

As described above, according to the file processing method and the electronic device supporting the method of the present disclosure, the present disclosure may more freely operate a file, maintaining a security function.

isAlthough the present disclosure has been described with an exemplary embodiment, various changes and modifications is suggested to one skilled in the art. It is intended that the present disclosure encompass such changes and modifications as fall within the scope of the appended claims.

What is claimed is:

1. An electronic device supporting file processing, the electronic device comprising:
a storage unit configured to comprise a normal region storing a normal file related to a function operating in a non-security environment and a secure region storing a secure file related to a function operating in a security environment; and
a control unit configured to read the normal file stored in the normal region in response to a file transfer request and to write a read file to the secure region, or read the secure file stored in the secure region in response to a file transfer request and to write a read file to the normal region.

2. The electronic device according to claim 1, wherein the control unit includes:
a non-security environment processor configured to support the non-security environment;
a shared agent configured to support migration or copying of the normal file in the normal region to the secure region and migration or copying of the secure file in the secure region to the normal region; and
a security environment processor configured to support the security environment.

3. The electronic device according to claim 2, wherein the shared agent includes at least normal file read and write rights with respect to the normal region and secure file read and write rights with respect to the secure region.

4. The electronic device according to claim 3, wherein the shared agent is configured to:
receive a normal file storage location to be transferred from the non-security environment processor when there is the normal file transfer request, directly read a file from the normal region and then write the file to the secure region directly; or
receive a secure file storage location to be transferred from the security environment processor when there is the secure file transfer request, directly read a file from the secure region and then write the file to the normal region directly.

5. The electronic device according to claim 2, wherein the shared agent is configured to:
receive the normal file from the non-security environment processor upon the normal file transfer request to transfer a received file to a processor managing reading from and writing to the secure region, or check activation of the security environment upon the normal file transfer request to call the security environment process to activate an inactivated security environment; or
request, upon the secure file transfer request, a processor managing reading from and writing to the secure region to read the secure file to be transferred and collect a decrypted secure file.

6. The electronic device according to claim 1, further comprising a display unit configured to display at least one of a screen for selecting the normal file in the normal region, a screen for selecting a folder location in the secure region to store a selected normal file, a screen for selecting the secure file in the secure region, and a screen for selecting a folder location in the normal region to store a selected secure file.

7. The electronic device according to claim 1, wherein the control unit is configured to:
allow the normal file to be stored in the secure region related to a secure application similar to a normal application related to the selected normal file, or
allow the secure file to be stored in the normal region related to a normal application similar to a secure application related to the selected secure file.

8. The electronic device according to claim 7, wherein the control unit is configured to:
allow the normal file to be stored by default in a folder related to a specified normal application when there is no similar normal application, or
allow the secure file to be stored in a folder related to a pre-specified secure application when there is no similar secure application.

9. The electronic device according to claim 1, wherein the control unit is configured to:
allow the normal file to be migrated or copied to the secure region in response to the file transfer request, or
allow the secure file to be migrated or copied to the normal region in response to the file transfer request.

10. A file processing method comprising:
providing a non-security environment or security environment; and
storing a file comprising reading a normal file from a normal region in a storage unit related to the non-security environment during execution of the non-security environment to write a read file to a secure region of the storage unit operating in the security environment, reading a secure file from the secure region in the security environment to write a read file to the normal region, or reading the normal file from the normal region in the security environment to write a read file to the secure region.

11. The file processing method according to claim 10, wherein storing the file includes:
receiving the stored location of the normal file from a non-security environment processor supporting the non-security environment by the shared agent;
reading the normal file from the normal region by the shared agent; and
using a processor managing reading from and writing to the secure region to store the normal file in the secure region by the shared agent.

12. The file processing method according to claim 10, wherein storing the file includes:
receiving the normal file from the non-security environment processor supporting the non-security environment by the shared agent;
transferring the normal file to a security environment processor supporting the security environment by the shared agent; and
storing the normal file in the secure region by the security environment processor.

13. The file processing method according to claim 10, wherein storing the file includes:
receiving the stored location of the secure file from the security environment processor supporting the security environment by the shared agent;
using a processor managing reading from and writing to the secure region to obtain a decrypted secure file by the shared agent; and
storing the decrypted secure file in the normal region by the shared agent.

14. The file processing method according to claim 10, wherein storing the file includes receiving a decrypted secure file to be transferred from the security environment processor supporting the security environment by the shared agent, and storing the decrypted secure file in the normal region by the shared agent.

15. The file processing method according to claim 10, wherein storing the file further comprises:
checking activation of the security environment when there is a normal file transfer request; and
activating the security environment when the security environment is in an inactivated state.

16. The file processing method according to claim 10, further comprising at least one of:
displaying a screen including a file icon corresponding to at least one normal file related to an operation of a specific normal application in the non-security environment;
displaying a menu item for requesting migration or copying of the normal file; and
displaying a list of folders in the secure region to store the normal file when there is a file migration or copying request, or displaying a folder in the secure region to store the normal file by default when there is the file migration or copying request.

17. The file processing method according to claim 10, further comprising at least one of:
displaying a screen including a file icon corresponding to at least one secure file related to an operation of a specific secure application in the security environment;
displaying a menu item for requesting migration or copying of the secure file; and
displaying a list of folders in the normal region to store the secure file when there is a file migration or copying request, or displaying a folder in the normal region to store the secure file when there is the file migration or copying request.

18. The file processing method according to claim 10, further comprising at least one of:
displaying a list of normal files to be transferred through a request in the security environment;
displaying a menu item for requesting migration or copying of the normal file; and
displaying a list of folders for folder selection of the secure region to store the normal file or displaying a specific folder in the secure region to store by default.

19. The file processing method according to claim 10, wherein storing the file includes at least one of:
storing the normal file in a folder in a secure application similar to a normal application related to the selected normal file;
storing the secure file in a folder related to a pre-defined secure application when there is no similar secure application;
storing the secure file in a folder in a normal application similar to a secure application related to the selected secure file;
storing the normal file in a folder related to a specified normal application by default when there is no similar normal application.

20. The file processing method according to claim 10, wherein storing the file includes at least one of:
migrating or copying the normal file to the secure region in response to the file transfer request; and
migrating or copying the secure file to the normal region in response to the file transfer request.
